(19) United States
(12) Patent Application Publication
(10) Pub. No.: US 2012/0063362 A1
(43) Pub. Date: Mar. 15, 2012

(54) METHOD AND APPARATUS FOR COMPUTING PATHS TO DESTINATIONS IN NETWORKS HAVING LINK CONSTRAINTS

(76) Inventor: Thippanna Hongal, Fremont, CA (US)

(21) Appl. No.: 12/878,375

(22) Filed: Sep. 9, 2010

(51) Int. Cl. H04L 12/28

(52) U.S. Cl. 370/255

(57) ABSTRACT

A capability is provided for computing paths to destinations in networks having link constraints. An improved Constrained Shortest Path First (CSPF) algorithm is provided for computing a path from a source node to a destination node through a network. The improved CSPF algorithm uses neighbor node lists, in addition to a tentative node list and a paths list, for computing a path. The improved CSPF algorithm, during path computation, maintains a tentative node list including nodes selected for inclusion within the path. The tentative node list specifies the computed path. The improved CSPF algorithm, for each node selected for inclusion within the tentative node list, uses a neighbor node list for the selected node, and selects a neighbor node from the neighbor node list for inclusion within the tentative node list. The neighbor node list for a selected node includes a plurality of neighbor nodes of the selected node, where the neighbor nodes of the neighbor node list are arranged within the neighbor node list based on link constraints of a plurality of links between the selected node and the respective neighbor nodes of the selected node.

### FIELD OF THE INVENTION

The invention relates generally to communication networks and, more specifically but not exclusively, to computation of paths in communication networks having link constraints.

### BACKGROUND

The computation of paths within a communication network, e.g., paths for tunnels through the communication network, is generally performed in either an unconstrained or a constrained manner. For unconstrained path computation, such as according to a Shortest Path First (SPF) algorithm, a path computation device may determine a shortest path between a source node and a destination node using any available links in the communication network. For constrained path computation, such as according to a Constrained SPF (CSPF) algorithm, however, a path computation device may determine a shortest path between a source node and a destination node that satisfies one or more constraints. The constraints may include one or more of end-to-end delay, maximum number of nodes/links traversed, minimum link capacities associated with the links, maximum link bandwidths associated with links, costs associated with links, administrative constraints for avoiding and/or including certain links in the path, and the like. For a given source node and destination node, the path computed using CSPF may be the same as, or completely different than, the path computed using SPF, depending on the network and the constraint(s) to be satisfied.

In Multiprotocol Label Switching (MPLS) networks, paths computed for use in transporting traffic are Label Switched Paths (LSPs). In MPLS networks, unconstrained and constrained path computation algorithms, e.g., SPF or CSPF algorithms as described above, may be used to compute the LSPs which are established within the MPLS network for use in transporting traffic. In such MPLS networks, an interior Gateway Protocol (IGP) may be used for determining shortest paths within the MPLS network. For SPF LSPs, for example, the potential route of the LSP is based on the IGP shortest path and the configuration of the hops in the path, regardless of any constraints of the links in the network. As a result, for SPF LSPs, if the shortest path does not have enough available bandwidth, the LSP will not be operational. By contrast, for CSPF LSPs, for example, the potential route of the LSP is based on the IGP shortest path and configuration of the hops in the path, while taking into account any constraints of the links in the network. As such, unlike SPF-based LSPs, CSPF-based LSPs have the potential to avoid areas of the MPLS network that do not satisfy the needed or desired constraints.

While CSPF provides various advantages, existing CSPF algorithms, disadvantageously, have high computation costs associated therewith.

### SUMMARY

Various deficiencies in the prior art are addressed by embodiments for computing paths to destinations in networks having link constraints.

In one embodiment, an improved Constrained Shortest Path First (CSPF) algorithm is provided for computing a path from a source node to a destination node through a network. The improved CSPF algorithm uses neighbor node lists, in addition to a tentative node list and a paths list, for computing a path. The improved CSPF algorithm, during path computation, maintains a tentative node list including nodes selected for inclusion within the path. The tentative node list specifies the computed path. The improved CSPF algorithm, for each node selected for inclusion within the tentative node list, uses a neighbor node list for the selected node, and selects a neighbor node from the neighbor node list for inclusion within the tentative node list. The neighbor node list for a selected node includes a plurality of neighbor nodes of the selected node, where the neighbor nodes of the neighbor node list are arranged within the neighbor node list based on link constraints of a plurality of links between the selected node and the respective neighbor nodes of the selected node. In this manner, each node that is already included in the tentative node list is guaranteed to meet the specified link constraint(s).

In one embodiment, a method for computing a path through a network includes selecting a node for the path where the selected node is included in a tentative list of nodes for the path, obtaining a neighbor node list for the selected node, and adding one of the neighbor nodes from the neighbor node list to the tentative list of nodes for the path. The tentative node list is used for computing the path through the network. The neighbor node list includes a plurality of neighbor nodes of the selected node, and the neighbor nodes of the neighbor node list are arranged within the neighbor node list based on link constraints of a plurality of links between the selected node and the respective neighbor nodes of the selected node. This method may be repeated for determining each of the nodes which will form the computed path.

### BRIEF DESCRIPTION OF THE DRAWINGS

The teachings herein can be readily understood by considering the following detailed description in conjunction with the accompanying drawings, in which:

FIG. 1 depicts a high-level block diagram of an exemplary system for illustrating use of an improved CSPF algorithm;

FIG. 2 depicts one embodiment of a method for using a neighbor node list for selecting a neighbor node for inclusion within a tentative node list used for computing a path through a network;

FIG. 3 depicts one embodiment of a method for building a neighbor node list for a selected node of a tentative node list;

FIG. 4 depicts one embodiment of a method for using the neighbor node selection process of FIG. 2 during path computation when establishing a path in a network;

FIG. 5 depicts a high-level block diagram of a path computation device configured for performing an improved CSPF algorithm; and

FIG. 6 depicts a high-level block diagram of a computer suitable for use in performing the functions described herein.

To facilitate understanding, identical reference numerals have been used, where possible, to designate identical elements that are common to the figures.

### DETAILED DESCRIPTION OF THE INVENTION

An improved Constrained Shortest Path First (CSPF) capability is depicted and described herein. The improved CSPF capability provides an improved mechanism for computing a path from a source node to a destination node in a network having link constraints. The improved CSPF capability enables computation of better paths, and in less time, than when existing CSPF algorithms are used for path computation.

Although the path computation capability is primarily depicted and described herein within the context of a particular type of network having link constraints (namely, a Multiprotocol Label Switching (MPLS) network), it will be appreciated that the path computation capability may be used in other types of networks having link constraints.

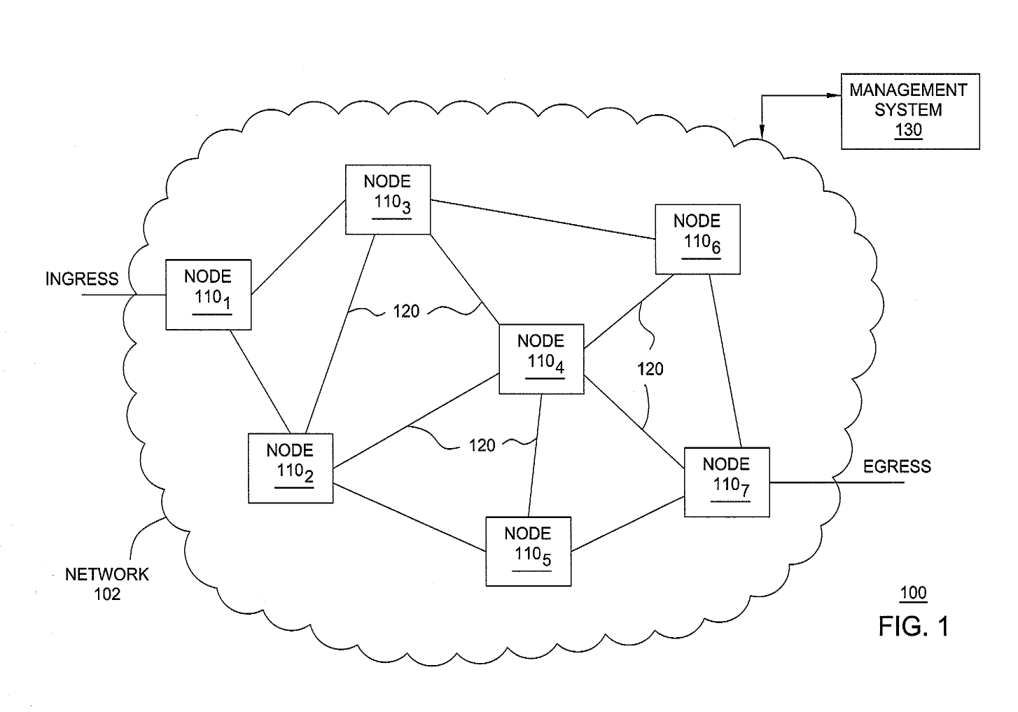

FIG. 1 depicts a high-level block diagram of an exemplary system for illustrating use of an improved CSPF algorithm.

As depicted in FIG. 1, exemplary system 100 includes a network 102, which includes seven nodes 110₁-110₇ (collectively, nodes 110) that are interconnected via a plurality of communication links 120 (collectively, communication links 120). The network 102 is managed by a management system 130, which may provide any suitable management functions for network 102.

The network 102 may be any suitable type of network and, thus, the nodes 110 may be any suitable types of nodes. For example, the network 102 may be an MPLS network in which nodes 110 are label switching routers (LSRs). The network 102 may be any other suitable type of network in which CSPF and/or CSPF-type algorithms may be used for path computation.

The nodes 110 each are configured for transporting traffic within the network 102. The nodes 110 may transport traffic within network 102 using any suitable protocols (e.g., Internet Protocol (IP), MPLS, and the like, as well as various combinations thereof).

The nodes 110 each are configured to collect link state information associated with the communication link(s) 120 to which each node 110 is connected. The nodes 110 each are further configured to flood the collected link state information within network 102. The collection and flooding of link state information may be performed in any suitable manner, e.g., using an Interior Gateway Protocol (IGP) supporting link-state, such as Open Shortest Path First (OSPF), Intermediate System to Intermediate System (ISIS), or any other suitable protocol. In this manner, each node 110 receives link state information associated with network 102 and, thus, each node 110 is able to maintain a database including information suitable for use in computing paths using the improved CSPF algorithm (e.g., network topology information, link state information, and the like). This type of database is typically referred to as a Traffic Engineering (TE) database. The processes for exchanging such information and for maintaining such databases will be understood by one skilled in the art.

The nodes 110 also may be configured to store link constraints for use in computing paths for network 102.

The link constraints may include any suitable link constraints which may be evaluated within the context of path computation. For example, the link constraints may include one or more of a link utilization for the link, a minimum link capacity required for a link, a maximum link bandwidth allowed for a link, a link cost associated with a link, an administrative constraint associated with the link, and the like, as well as various combinations thereof.

The link constraints may be configured on the nodes 110 in any suitable manner. For example, the link constraints may be pre-configured on the nodes 110 (e.g., automatically and/or by administrators), specified when requesting path computation or establishment, and the like, as well as various combinations thereof. In such embodiments, the link constraints may be provided to the nodes 110, for storage on the nodes 110, from any suitable source(s) of link constraints (e.g., a management system such as MS 130, or any other suitable source).

Although primarily depicted and described herein with respect to embodiments in which link constraints are configured on the nodes 110, in other embodiments the link constraints may not be stored on the nodes 110. For example, in embodiments in which path computation is performed by a device or devices other than nodes 110 (e.g., by a management system, such as MS 130), link constraints may only be available to the device(s) computing the paths.

In network 102, at least a portion of the nodes 110 may be configured to operate as ingress nodes into network 102 and, similarly, at least a portion of the nodes 110 may be configured to operate as egress nodes from network 102. In FIG. 1, for example, for a given path between node 110₁ and node 110₇, node 110₁ operates as an ingress node for the path and node 110₇ operates as an egress node for the path. It will be appreciated that each of the nodes 110 may operate as an ingress node only, an egress node only, or both an ingress and egress node (e.g., for different traffic flows).

As each of the nodes 110 may be configured to operate as an ingress node and/or as an egress node, each node 110 configured to operate as an ingress node may be referred to as an ingress node 110 and each node 110 configured to operate as an egress node may be referred to as an egress node 110.

In one embodiment, the ingress nodes 110 each are configured for computing paths to egress nodes 110, thereby enabling establishment of connections, from the ingress nodes 110 to the egress nodes 110, configured for transporting traffic via the network 102. The ingress nodes 110, in response to path computation requests, compute the requested paths based on the network information (e.g., network topology, link state, and the like, which may be available in a TE database and/or any other suitable database or databases) and link constraints available to the ingress nodes 110, respectively. In one embodiment, the ingress nodes 110 are configured for computing paths using an improved Constrained Shorted Path First (CSPF) algorithm. The ingress nodes 110, upon computation of paths, may then initiate establishment of connections using the computed paths. The ingress nodes 110 may then transmit information to the egress nodes 110 via the established connections, at which point the egress nodes 110 may then forward the information to other networks and devices.

In one embodiment, MS 130 is configured for computing paths from ingress nodes 110 to egress nodes 110, thereby enabling establishing of connections, from the ingress nodes 110 to the egress nodes 110, configured for transporting traffic via the network 102. The MS 130, in response to path computation requests, computes the requested paths based on the network information (e.g., network topology, link state, and the like, which may be available in a TE database and/or any other suitable database or databases) and link constraints available to MS 130. In one embodiment, MS 130 is configured for computing paths using an improved Constrained Shorted Path First (CSPF) algorithm. The MS 130, upon computing a path, transmits path configuration information for the computed path to the relevant nodes 110, where the path configuration information may be used to establish a connection via the computed path within network 102. The ingress node 110 of the computed path may then transmit information to the egress node 110 via the connection, at which point the egress node 110 may then forward the information to other networks and devices.

As described herein, multiple types of devices may compute paths using the improved CSPF capability (e.g., nodes 110, MS 130, and the like). Accordingly, with respect to path computation using the improved CSPF capability, such devices may be referred to collectively, and more generally, as path computation devices.

In one embodiment, as described herein, a path computation device is configured for computing paths using an improved Constrained Shorted Path First (CSPF) algorithm.

The improved CSPF algorithm provides improvements over existing CSPF algorithms, such as the existing CSPF algorithm defined in the Internet Engineering Task Force (IETF) Draft Standard entitled “Constrained Shortest Path First,” by Manayya, which is hereby incorporated by reference herein in its entirety.

As described in the IETF CSPF Draft Standard, the existing CSPF algorithm uses two databases during path computation: namely, a paths database (denoted as PATHS) and a tentative node database (denoted as TENT), where PATHS stores the information of the shortest path tree while TENT stores the information of tentative nodes which have been attempted before finding the shortest path. The PATHS and TENT databases also may be referred to herein as a paths list and a tentative node list.

The improved CSPF algorithm provided herein modifies the existing CSPF algorithms by using neighbor node lists, in addition to a tentative node list and a paths list, for computing a path. The improved CSPF algorithm, during path computation, maintains a tentative node list including nodes selected for inclusion within the path. The tentative node list specifies the computed path. The improved CSPF algorithm, for each node selected for inclusion within the tentative node list, uses a neighbor node list for the selected node, and selects a neighbor node from the neighbor node list for inclusion within the tentative node list. The neighbor node list for a selected node includes a plurality of neighbor nodes of the selected node and the neighbor node list is built based on link constraints of the respective links between the selected node and the neighbor nodes of the selected node (e.g., the neighbor nodes included within the neighbor node list for the selected node may be ordered within the neighbor node list based on one or more link constraints of the respective links between the selected node and the neighbor nodes of the selected node).

As noted herein, by building the neighbor node list for the given node before adding the neighbor node into the tentative node list, it is possible to ensure that each neighbor node that is already included in the tentative node list is guaranteed to meet the specified link constraint(s).

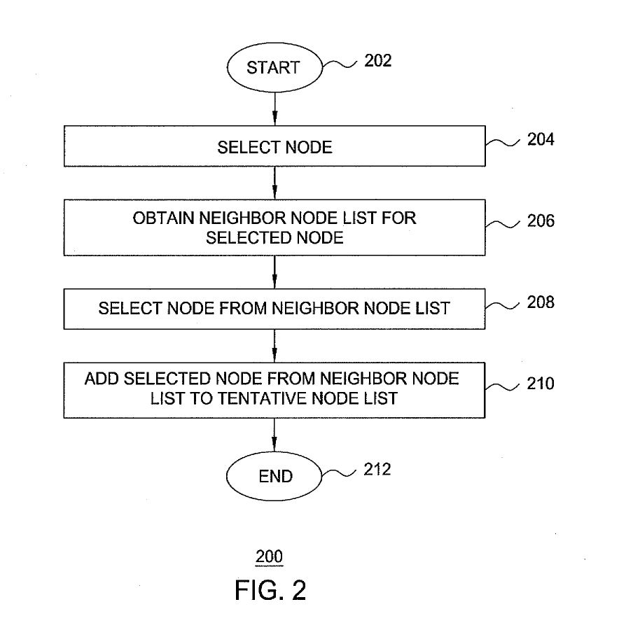

FIG. 2 depicts one embodiment of a method for using a neighbor node list for selecting a neighbor node for inclusion within a tentative node list used for computing a path through a network.

The method 200 of FIG. 2 may be executed by any suitable path computation device (e.g., the ingress node from which the computed path will originate, a network node on behalf of the ingress node from which the computed path will originate, a management system, and the like).

At step 202, method 200 begins.

At step 204, a node is selected. The node may be selected in any suitable manner. In one embodiment, the selected node is the previous node that was added to the tentative node list.

At step 206, a neighbor node list is obtained for the selected node.

The neighbor node list includes a plurality of neighbor nodes of the selected node, wherein the neighbor nodes are arranged within the neighbor node list based on link constraints of a plurality of links between the selected node and the respective neighbor nodes.

The neighbor node list may be obtained in any suitable manner.

In one embodiment, in which the neighbor node list is pre-computed, the neighbor node list is received (e.g., from a local memory of the path computation device executing method 200, from a remove device, and the like).

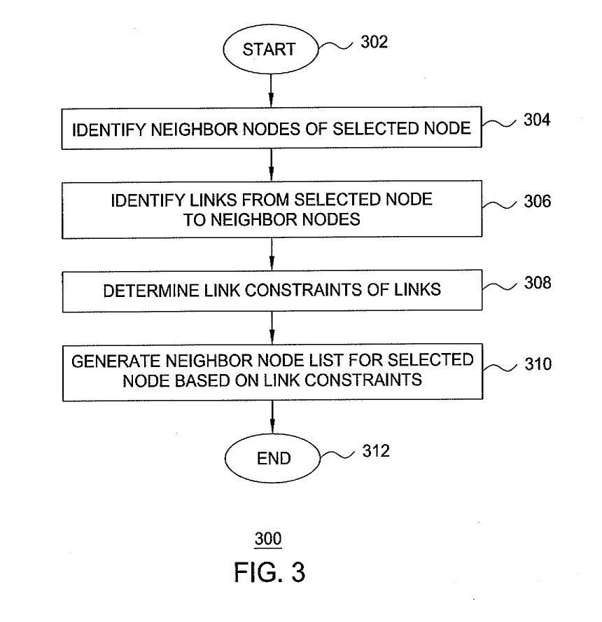

In one embodiment, in which the neighbor node list is not pre-computed, the neighbor node list is built. An exemplary embodiment of a method for building a neighbor node list for a selected node is depicted and described with respect to FIG. 3.

At step 208, a neighbor node is selected from the neighbor node list. In one embodiment, in which the order in which the neighbor nodes are listed in the neighbor node list is based on one or more link constraints, the neighbor node is selected based on the ordering of the neighbor nodes within the neighbor node list. For example, where the neighbor nodes are ordered within the neighbor node list based on link utilization, the first neighbor node in the neighbor node list may be selected (i.e., the least-utilized link). Similarly, for example, where the neighbor nodes are ordered within the neighbor node list based on link cost, the first neighbor node within the neighbor node list may be selected (i.e., the lowest cost link). As noted above, the ordering of the neighbor nodes in this manner simplifies selection of the neighbor node associated with the optimum link for the path based on the link constraints under consideration.

At step 210, the neighbor node selected from the neighbor node list is added to the tentative node list associated with computation of the path.

At step 212, method 200 ends.

Although depicted and described as ending, it will be appreciated that method 200 may be performed for each neighbor node of the tentative node list, where the neighbor node selected from the neighbor node list and added to the tentative node list in step 210 of the current execution of method 200 is used as the selected node at step 204 of the next execution of method 200. In this manner, method 200 may be executed for determining each node along the path as the path is computed.

FIG. 3 depicts one embodiment of a method for building a neighbor node list for a selected node of a tentative node list.

The method 300 of FIG. 3 may be executed by any suitable device (e.g., a path computation device, a device on behalf of a path computation device, and the like).

At step 302, method 300 begins.

At step 304, the neighbor nodes of the selected node are identified. The neighbor nodes of the selected node may be identified in any suitable manner (e.g., from topology information or any other suitable information).

At step 306, the links between the selected node and the neighbor nodes are identified. The links between the selected node and neighbor nodes may be identified in any suitable manner (e.g., from topology information, link state information, or any other suitable information).

At step 308, link constraints associated with the identified links are determined. The link constraints may include, for each link, one or more link constraints for the link. The link constraints may include any suitable link constraints (e.g., a link utilization for a link, a minimum link capacity required for a link, a maximum link bandwidth allowed for a link, a link cost associated with a link, an administrative constraint associated with the link, and the like, as well as various combinations thereof).

At step 310, a neighbor node list is generated for the selected node. The neighbor node list includes the identified neighbors. The neighbor node list is generated based on the link constraints of the links associated with the identified neighbors. In one embodiment, the order in which the neighbor nodes are listed in the neighbor node list is based on one or more link constraints. For example, where link utilization is the link constraint being considered, the neighbor nodes may be listed in an order from the node associated with the least-utilized link to the node associated with the most-utilized link. Similarly, for example, where link cost is the link constraint being considered, the neighbor nodes may be listed in an order from the node associated with the lowest cost link to the node associated with the highest cost link. As described herein, combinations of such constraint types may be used for ordering the neighbor nodes within the neighbor node list. The ordering of the neighbor nodes within the neighbor node list in this manner enables easy selection of the neighbor node associated with the optimum link for the path based on the link constraints under consideration.

At step 312, method 300 ends.

Although depicted and described as ending, it will be appreciated that method 300 may be executed at any suitable time(s). For example, where neighbor node lists are computed prior to path computation, method 300 may be performed in any manner suitable for enabling the path computation device to have access to neighbor node lists for use in path computation, such as periodically, in response to one or more trigger conditions (e.g., a change of link state, a change of one or more link constraints, and the like), and the like, as well as various combinations thereof. For example, where neighbor node lists are computed as part of the path computation process, method 300 may be performed for each node of the tentative node list in order to compute paths during path computation.

Although depicted and described as ending, it will be appreciated that, prior to or during path computation, in which multiple neighbor nodes are evaluated for inclusion within the tentative node list, the method 300 may be repeated for each of the neighbor nodes in order to improve each neighbor node selection operation that is performed during path computation.

In one embodiment, method 300 of FIG. 3 may be performed as a pre-process for building neighbor node lists for nodes of a network prior to execution of a CSPF path computation algorithm for computing a path through the network.

In one embodiment, method 300 of FIG. 3 may be performed as part of a CSPF path computation algorithm for computing a path through a network (e.g., as a sub-routine for selecting a neighbor node, of a target node, for inclusion within a tentative node list when the target node is being considered for processing).

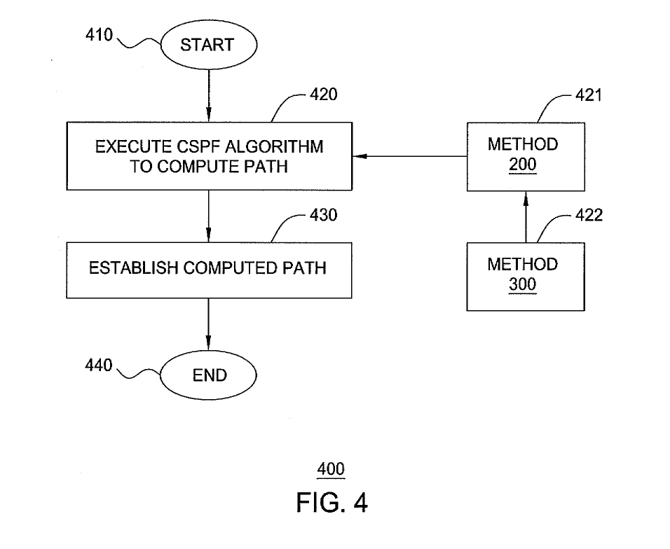

An exemplary embodiment illustrating (1) use of the method 200 of FIG. 2 as an input to the path computation process, and (2) use of the method 300 of FIG. 3 as an input into the neighbor node selection process of FIG. 2, is depicted and described with respect to FIG. 4.

FIG. 4 depicts one embodiment of a method for using the neighbor node selection process of FIG. 2 during path computation when establishing a path in a network.

At step 410, method 400 begins.

At step 420, a CSPF algorithm is executed for computing a path through the network.

As indicated by step 421, the neighbor node selection process 200 of FIG. 2 is used as an input into the CSPF algorithm (e.g., as described herein, being executed prior to execution of step 420 (or even method 400) or being executed as needed during execution of step 420). In either case, the neighbor node selection process 200 may be called as many times as necessary during CSPF path computation for purposes of improving selection of neighbor nodes based on link constraints.

As indicated by step 422, the neighbor node list generation process 300 of FIG. 3 may be used as an input into method 200 of FIG. 2 (e.g., for use as step 206 of FIG. 2, as described herein).

At step 430, the computed path resulting from the CSPF algorithm is established within the network via signaling within the network. The path may be established in any suitable manner. In one embodiment, for example, in which the path is an LSP in an MPLS network, the computed path may be formed into a strict-hop Explicit Route Object (ERO) which is passed to a Resource Reservation Protocol (RSVP) process which uses the ERO for signaling and establishment of the LSP in the network.

At step 440, method 400 ends.

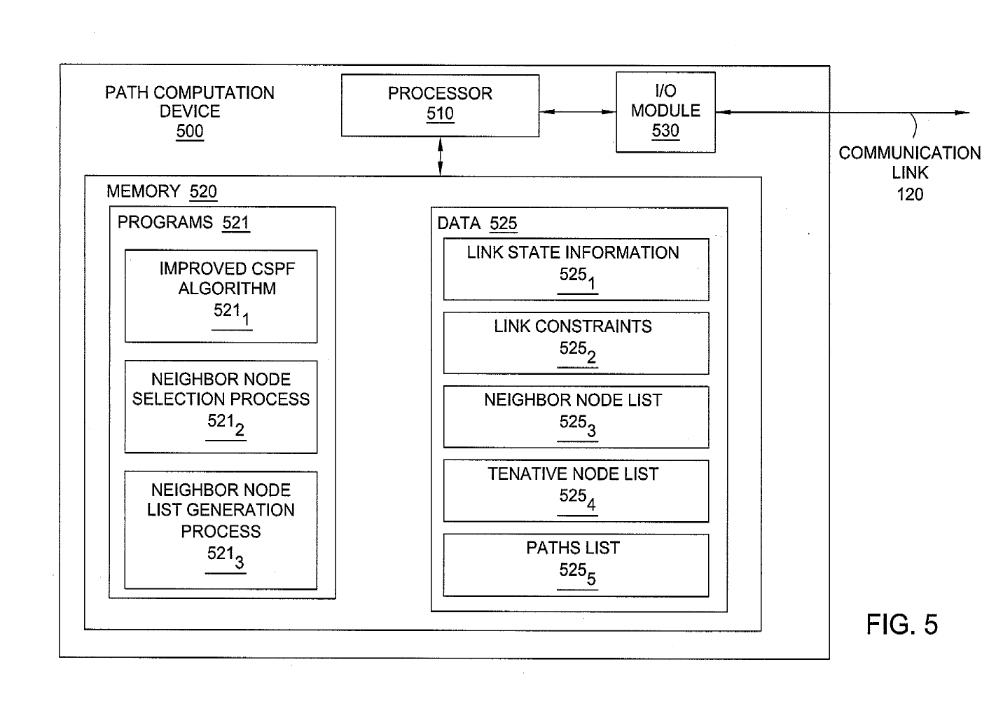

FIG. 5 depicts a high-level block diagram of a path computation device configured for performing an improved CSPF algorithm.

As depicted in FIG. 5, path computation device 500 includes a processor 510, a memory 520, and an input-output (I/O) module 530, which are configured to cooperate for providing various functions depicted and described herein.

The I/O module 530 may support one or more interfaces to nodes and/or devices via one or more associated communication links (e.g., via one or more of the communication links 120). For example, I/O module 530 may receive, via communication link 120, information suitable for use in executing the improved CSPF algorithm (e.g., link state information for storage in memory 520, link constraints for storage in memory 520, and the like), signaling requesting path computation, signaling requesting and/or associated with path establishment, and the like, as well as various combinations thereof. For example, I/O module 530 may receive, from processor 510, information associated with execution of the improved CSPF algorithm on other nodes and/or devices (e.g., link state information for distribution to nodes 110), signaling requesting path establishment, and the like, as well as various combinations thereof. The I/O module 530 may support communication of any other suitable types of information.

The memory 520 includes programs 521 and data 525. The programs 521 include an improved CSPF algorithm 521₁, a neighbor node selection process 521₂ (e.g., the method 200 of FIG. 2), and a neighbor node list generation process 521₃ (e.g., the method 300 of FIG. 3). The programs 521 may include any other necessary and/or desired programs. The data 525 includes link state information 525₁, link constraints 525₂, neighbor node lists 525₃, tentative node lists 525₄, and a paths list 525₅. The data 525 may include any other necessary and/or desired data.

The processor 510 is configured for accessing memory 520 for providing various functions, e.g., accessing programs 521 from memory 520 in order to execute the programs 521, storing data and/or retrieving data from memory 520 (e.g., storing data received via the communication link 120, storing data produced during execution of programs 521, retrieving data for propagation via the communication link 120, and the like, as well as various combinations thereof). The processor 510 may provide and/or support any other capabilities for enabling operation of path computation device 500 in accordance with the improved CSPF capability.

As will be appreciated, path computation device 500 of FIG. 5 is suitable for use as any of the nodes 110 depicted and described herein, as management system 130 depicted and described herein, or in any other manner necessary or desirable for providing the improved CSPF capability within a communication network.

Although primarily depicted and described herein with respect to embodiments in which paths are computed by the sources of those paths, it will be appreciated that in other embodiments paths may be computed by any suitable path computation device (e.g., a management system or any other suitable device), such that any suitable path computation device may compute a path between a source node and a destination node while accounting for link constraints.

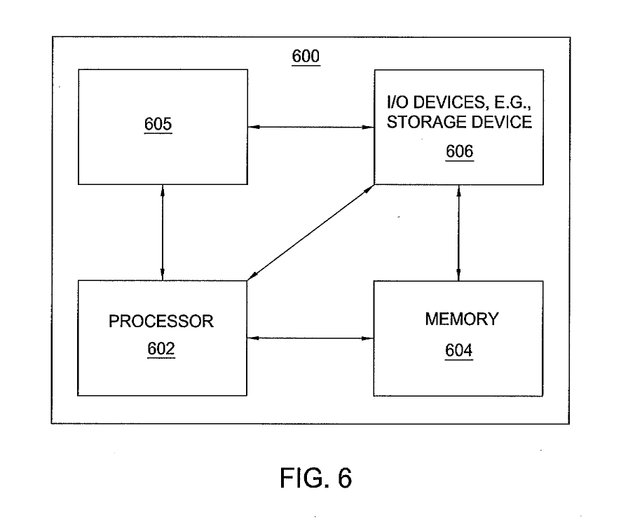

FIG. 6 depicts a high-level block diagram of a computer suitable for use in performing functions described herein.

As depicted in FIG. 6, computer 600 includes a processor element 602 (e.g., a central processing unit (CPU) and/or other suitable processor(s)), a memory 604 (e.g., random access memory (RAM), read only memory (ROM), and the like), an cooperating module/process 605, and various input/output devices 606 (e.g., a user input device (such as a keyboard, a keypad, a mouse, and the like), a user output device (such as a display, a speaker, and the like), an input port, an output port, a receiver, a transmitter, and storage devices (e.g., a tape drive, a floppy drive, a hard disk drive, a compact disk drive, and the like)).

It will be appreciated that the functions depicted and described herein may be implemented in software and/or hardware, e.g., using a general purpose computer, one or more application specific integrated circuits (ASIC), and/or any other hardware equivalents. In one embodiment, the cooperating process 605 can be loaded into memory 604 and executed by processor 602 to implement the functions as discussed herein. Thus, cooperating process 605 (including associated data structures) can be stored on a computer readable storage medium, e.g., RAM memory, magnetic or optical drive or diskette, and the like.

It is contemplated that some of the steps discussed herein as software methods may be implemented within hardware, for example, as circuitry that cooperates with the processor to perform various method steps. Portions of the functions/elements described herein may be implemented as a computer program product wherein computer instructions, when processed by a computer, adapt the operation of the computer such that the methods and/or techniques described herein are invoked or otherwise provided. Instructions for invoking the inventive methods may be stored in fixed or removable media, transmitted via a data stream in a broadcast or other signal-bearing medium, and/or stored within a memory within a computing device operating according to the instructions.

Although various embodiments which incorporate the teachings of the present invention have been shown and described in detail herein, those skilled in the art can readily devise many other varied embodiments that still incorporate these teachings.

What is claimed is:

1. A method for computing a path through a network, comprising:
selecting a node for the path, wherein the selected node is included in a tentative list of nodes for the path;
obtaining a neighbor node list for the selected node, wherein the neighbor node list includes a plurality of neighbor nodes of the selected node, wherein the neighbor nodes are arranged within the neighbor node list based on link constraints of a plurality of links between the selected node and the respective neighbor nodes; and
adding one of the neighbor nodes from the neighbor node list to the tentative list of nodes for the path.

2. The method of claim 1, wherein obtaining the neighbor node list for the selected node comprises one of:
receiving the neighbor node list for the selected node; and
building the neighbor node list for the selected node.

3. The method of claim 2, wherein building the neighbor node list for the selected node comprises:
identifying each of a plurality of nodes that are direct neighbor nodes of the selected node; and
adding each of the identified neighbor nodes to the neighbor node list.

4. The method of claim 1, wherein the identified neighbor nodes are listed in the neighbor node list in an order that is determined based on, for each of the links between the selected node and the respective neighbor nodes of the selected node, the link constraint associated with the link.

5. The method of claim 4, wherein, for each link, the link constraints comprise at least one of a link utilization for the link, a minimum link capacity required for the link, a maximum link bandwidth allowed for the link, a link cost associated with the link, and an administrative constraint associated with the link.

6. The method of claim 1, wherein the path is a path from a source node to a destination node, the method further comprising:
when the destination node of the path is identified, setting the tentative list of nodes of the path as the computed path from the source node to the destination node.

7. The method of claim 6, further comprising:
initiating signaling for establishing the computed path between the source node and the destination node.

8. An apparatus for computing a path through a network, comprising:
a processor configured for:
selecting a node for the path, wherein the selected node is included in a tentative list of nodes for the path;
obtaining a neighbor node list for the selected node, wherein the neighbor node list includes a plurality of neighbor nodes of the selected node, wherein the neighbor nodes are arranged within the neighbor node list based on link constraints of a plurality of links between the selected node and the respective neighbor nodes; and
adding one of the neighbor nodes from the neighbor node list to the tentative list of nodes for the path.

9. The apparatus of claim 8, wherein obtaining the neighbor node list for the selected node comprises one of:
receiving the neighbor node list for the selected node; and
building the neighbor node list for the selected node.

10. The apparatus of claim 9, wherein building the neighbor node list for the selected node comprises:
identifying each of a plurality of nodes that are direct neighbor nodes of the selected node; and
adding each of the identified neighbor nodes to the neighbor node list.

11. The apparatus of claim 8, wherein the identified neighbor nodes are listed in the neighbor node list in an order that is determined based on, for each of the links between the selected node and the respective neighbor nodes of the selected node, the link constraint associated with the link.

12. The apparatus of claim 11, wherein, for each link, the link constraints comprise at least one of a link utilization for the link, a minimum link capacity required for the link, a maximum link bandwidth allowed for the link, a link cost associated with the link, and an administrative constraint associated with the link.

13. The apparatus of claim 8, wherein the path is a path from a source node to a destination node, wherein the processor is configured for:
when the destination node of the path is identified, setting the tentative list of nodes of the path as the computed path from the source node to the destination node.

14. The apparatus of claim 13, wherein the processor is configured for:
initiating signaling for establishing the computed path between the source node and the destination node.

15. A computer readable storage medium storing instructions which, when executed by a computer, cause the computer to perform a method for computing a path through a network, the method comprising:
selecting a node for the path, wherein the selected node is included in a tentative list of nodes for the path;
obtaining a neighbor node list for the selected node, wherein the neighbor node list includes a plurality of neighbor nodes of the selected node, wherein the neighbor nodes are arranged within the neighbor node list based on link constraints of a plurality of links between the selected node and the respective neighbor nodes of the selected node; and
adding one of the neighbor nodes from the neighbor node list to the tentative list of nodes for the path.

16. The computer readable storage medium of claim 15, wherein obtaining the neighbor node list for the selected node comprises one of:
receiving the neighbor node list for the selected node; and
building the neighbor node list for the selected node.

17. The computer readable storage medium of claim 16, wherein building the neighbor node list for the selected node comprises:
identifying each of a plurality of nodes that are direct neighbor nodes of the selected node; and
adding each of the identified neighbor nodes to the neighbor node list.

18. The computer readable storage medium of claim 15, wherein the identified neighbor nodes are listed in the neighbor node list in an order that is determined based on, for each of the links between the selected node and the respective neighbor nodes of the selected node, the link constraint associated with the link.

19. The computer readable storage medium of claim 18, wherein, for each link, the link constraints comprise at least one of a link utilization for the link, a minimum link capacity required for the link, a maximum link bandwidth allowed for the link, a link cost associated with the link, and an administrative constraint associated with the link.

20. The computer readable storage medium of claim 15, wherein the path is a path from a source node to a destination node, the method further comprising:
when the destination node of the path is identified, setting the tentative list of nodes of the path as the computed path from the source node to the destination node.
